(19) United States
(12) Patent Application Publication
(10) Pub. No.: US 2006/0261295 A1
(43) Pub. Date: Nov. 23, 2006

(54) Device for monitoring the flow of a fluid flowing through or from a conduit, such as a lubricant, and the monitoring method implemented by the device

(76) Inventor: Tiziano Barea, Busto Arsizio (Varese) (IT)

Correspondence Address: YOUNG & THOMPSON, 745 SOUTH 23RD STREET, 2ND FLOOR, ARLINGTON, VA, 22202, US

(21) Appl. No.: 10/547,667

(22) PCT Filed: Feb. 24, 2004
(86) PCT No.: PCT/EP04/01796

§ 371 Date: Mar. 15, 2006

(30) Foreign Application Priority Data
Mar. 4, 2003 (IT) MI2003A 000936

(51) Int. Cl. G01N 21/85

(52) U.S. Cl. 250/573

(57) ABSTRACT

A device for monitoring the flow of a fluid (3, 13) flowing through or from a conduit (2), such as a lubricant or an article treatment fluid; it includes light-emitting elements (1) arranged to irradiate a light radiation towards the flow and sensor elements (4) for sensing the image projected onto them by the fluid (3, 13) struck by the light radiation, the sensor elements (4) generating at least one output signal (11, 12) based on the presence thereon of the sensed fluid image. The method implemented by the device is also claimed.

The present invention relates to a device for monitoring the flow of a fluid flowing through or from a conduit, such as a lubricant or an article treatment fluid. The invention also relates to a method implemented by the said device.

In the present text, the term “fluid” means any element or flow which is liquid, gaseous or composed of particles or powders suspended in a gaseous or liquid means which transports them.

Processes are known which require precise monitoring of the state of feed of a fluid. For example, one of these is the well known lubrication process; in this process extremely small or large quantities of lubricant, such as oil, are fed through connection pipes between an oil pumping member and a member to be lubricated, for example the bearings of a machine tool spindle, or the tool of the actual machine while machining a workpiece. Such lubrication is evidently important because, as is obvious, any interruption therein would in the first case lead to breakage of the bearings, and in the second case the breakage of the tool.

Other processes also exist in which a fluid, for example a paint, a powder, etc., is sprayed onto an article; in such processes, a spraying interruption or irregularity would result in rejection of the pieces produced. In still further processes, such as fabric oiling with oils and/or specific substances, said substances are applied during the winding of a spool of yarn; again in this case, any interruption in the feed of said substances to the yarn treatment station in which spraying is carried out would represent a serious defect in the yarn oiling process.

From WO 01/36861 a method (and corresponding device) are known for monitoring the flow of the oil used with air to lubricate mechanical components. This method consists, inter alia, of using an optoelectronic sensor comprising a light source and a receiver, between which there is positioned a transparent portion of a conduit through which oil and air pass, directed towards a member to be lubricated. The receiver is connected to a control member which, on the basis of the light sensed by the receiver, modifies the intensity of the radiation emitted by the light source in order to maintain a constant light quantity striking the receiver notwithstanding the attenuation generated on the light by the fluid passing through the conduit. This control member is also connected to a circuit which, on the basis of the signals which cause the light source to modify the intensity of the emitted light, defines the quantity of oil fed to the lubricated member or the intensity of the air flow present in the said conduit, or deactivates said lubricated member (warning of any flow abnormalities through the conduit).

The aforedescribed known device therefore evaluates the fluid flow rate through the conduit, which however depends on continuous modifications to the intensity of the light generated by the light source, in order to maintain the value sensed by the receiver constant. The flow rate evaluation must therefore consider a light unit compensation time (to maintain the value sensed by the receiver constant), and it is not possible to achieve a flow rate evaluation within a very short time (i.e. within real time).

Moreover if the fluid passing through the conduit is not permeable to light (such as paint), the known device is unable to determine a correct flow rate of this fluid as the light source cannot be controlled in such a manner as to enable the receiver to receive a light signal.

The known solution does not enable measurement of a flow rate of fluid emitted (for example sprayed) by an atomizer or spray nozzle. Moreover, the known solution uses a simple optical sensor and does not enable fluid to be monitored through a conduit of large dimensions (such as those used for example to transport the water/oil emulsion for lubricating tools in numerically controlled automatic machines).

An object of the present invention is to provide a device able to monitor with absolute certainty the state of feed or flow interruption of a fluid fed to an operative zone or station from a relative tank or feed zone, such monitoring also being possible for a fluid which is not permeable to light.

Another object is to provide a device of the stated type which in no way influences the flow being monitored and which enable the state of the fluid and/or its flow rate to be directly determined, without this determination being subject to time variables related to adjustments within the device or in the operative modalities thereof.

Another object is to provide a device of the stated type which is of very small dimensions, such that the device can be easily applied in a place or on a machine in which a fluid of the stated type is used.

A further object is to provide a device of the stated type which is completely programmable to enable it to be easily adapted to the most disparate applications.

A further object of the present invention is to offer a method implemented by the aforesaid device.

These and further objects which will be apparent to the expert of the art are attained by a device and method in accordance with the accompanying claims.

The present invention will be more apparent from the accompanying drawing, which is provided by way of non-limiting example, and in which:

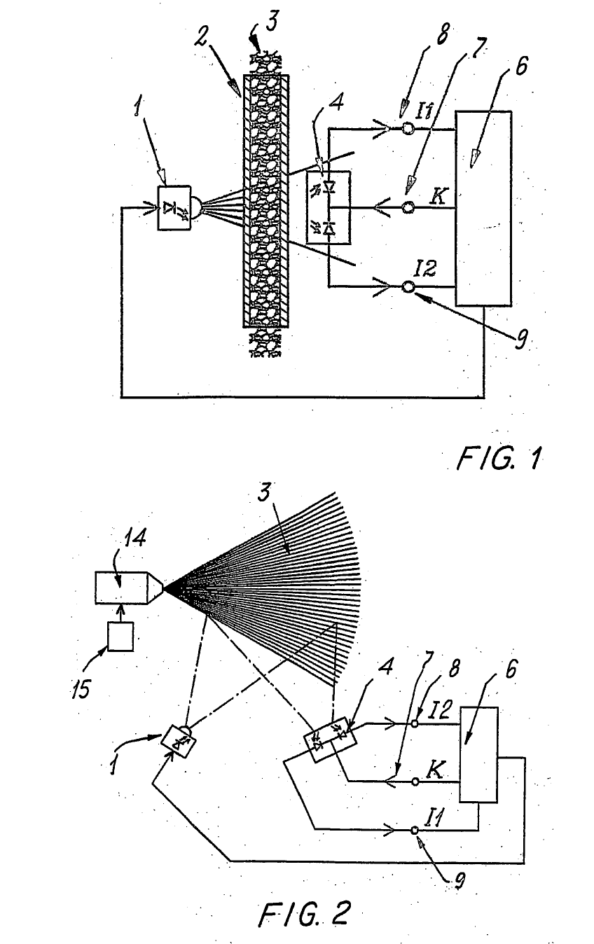

FIG. 1 is a schematic view of a first method of using the device;

FIG. 2 is a schematic view of a second method of using the device;

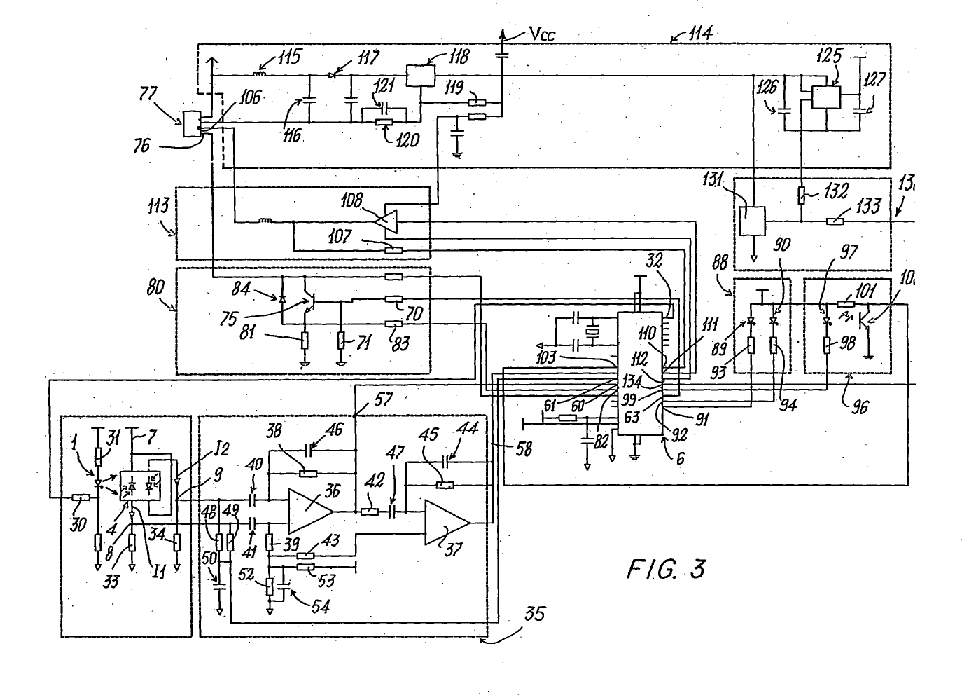

FIG. 3 shows a circuit schematic of one embodiment of the device of the invention.

With reference to said figures, in FIG. 1 the reference numeral 1 indicates a light transmitter consisting for example of a known diode (LED) model OP240A produced by OPTEK of the type with wavelength for example 960 nm, a typical wavelength in the infrared region; 2 indicates a tube or conduit for example of thermoplastic material, of the type used for feeding oil or air/oil mixtures. Through the tube 2 there is shown a typical air/oil flow 3 of the type used for example for lubricating the bearings of a machine tool, said fluid being fed through the tube 2 from a source in known manner. The tube 2 is transparent to light (in the example, to infrared light radiation) at least within that portion facing the light transmitter 1. It should be noted that the emitted light has a suitable wavelength (for example, within the infrared or ultraviolet range) to prevent interference with the tube 2.

The reference numeral 4 indicates a light sensitive sensor or receiver arranged to cooperate with the transmitter 1. In the example, this sensor 4 is sensitive to the infrared region, to be able to correctly sense the light emitted by the transmitter 1. The tube 2 is positioned between this latter and the sensor or receiver 4. This receiver can be, for example, a photodiode with a 1×5 mm sensitive area, model KOM2125 produced by SIEMENS, or an optical sensor with 1×4.2 mm sensitive area of the PSD (position sensor device) type, model S7105-05 produced by HAMAMATSU and also shown in the circuit schematic represented in FIG. 3; alternatively, the receiver 4 can be a CCD sensor of TSL 213 type, produced by Texas Instruments.

The transmitter 1 and receiver 4 are connected to a control unit 6, preferably of microprocessor type, arranged to evaluate signals, for example electric (current) or digital signals I1 and I2 generated by the receiver 4, which are fed to the unit 6 via outputs 8 and 9 of said receiver. On the basis of these signals and a predefined control and comparison algorithm, the control unit 6 evaluates whether there is fluid 3 in the tube 2, whether it is moving and also its flow rate. The purpose of this is to determine whether the feed of the fluid 3, for example to a mechanical member (not shown, for example a bearing as aforestated), is correct (for example for the purpose of lubrication).

The control unit 6 generates a reference signal K fed to an input 4 of the receiver 4.

In general, the light emitted by the transmitter 1 strikes the fluid feed tube 2; this light is then deflected by the irregularities formed by the fluid flow through the tube, and strikes the receiver 4 able to transform the light signal into electrical signals which, sensed by the unit 6, enable this latter to provide an image or profile of the image of the flow of the fluid 3 being monitored, which is hence related to the image sensed by said receiver 4. This is achieved by the method described in relation to FIG. 3.

FIG. 1 shows the use of the invention to determine the movement of a fluid within a tube or conduit, whereas FIG. 2 shows the use of the invention to determine the presence of an atomized fluid or a fluid defined by powder (suspended in another liquid or gaseous fluid).

In the figure under examination, in which parts corresponding to those of the already described figure are indicated by the same reference numerals, the light radiation emitted by the transmitter 1 strikes a spray of atomized fluid or powder 13 emerging from a nozzle 14 and is reflected towards the receiver 4 positioned on that side of the fluid 13 on which the transmitter 1 is also located. The light striking this latter causes it to emit electrical signals which reach the unit 6 to enable this, in the aforedescribed manner, to sense the presence of the spray 13, its intensity and, if required, also its direction in space. The unit 6 then acts on the feed of fluid to the nozzle 14 or on a support 15 for this latter, with which the nozzle is rigid, which can move (with translatory and/or rotary movement) in space (by virtue of a usual electric motor, not shown) to modify the direction and/or flow rate of the spray.

This “reflection” method, which can also be used to monitor a flow within a tube, also enables flows of fluids consisting of light-impermeable substances, such as paint, to be monitored.

The various components of the device of the invention are shown in FIG. 3, where they are indicated by the same reference numerals which identify them in the preceding figures.

FIG. 3 shows the receiver 4 defined by an optical position sensor of the PSD type, used to intercept the direct (FIG. 1) or reflected (FIG. 2) image; this image is formed by modulating the infrared light emitted by the transmitter 1 polarized by the polarization current from polarization resistors 30 and 31. A gate 32 of the microprocessor unit 6 is connected to the resistor 30 and is used to reduce the value of the current circulating through the transmitter (diode) 1 when the device of the invention is in the stand-by condition to limit the electricity consumed by the circuit and to prevent reduction of the average useful life of the component (the transmitter).

The sensor 4 is struck by the light reflected by the fluid leaving the nozzle 14 (FIG. 2) or by the constricted light originating from the transmitter of FIG. 1; in this second case, the sensor 4 senses the “shadow” of the flow of fluid which strikes it and on the basis of this defines the form and dimension of said fluid. The method of use of the transmitter 1 and sensor 4 shown in FIG. 1 can obviously be applied to FIG. 2 and vice versa.

As the sensor 4 is struck by a light (infrared) which is a function of the image of the monitored flow, the sensor 1 generates at its output terminals 8 and 9 (photodiode anodes) two currents I1 and I2 based on the position in which the infrared light image (flow profile) strikes the optical sensor 4. These currents I1 and I2 polarize respective resistors 33 and 34 and enable a potential difference to be generated across the resistors.

The electrical signals or currents I1 and I2 are processed by a two stage amplifier circuit 35 formed from operational amplifiers 36 and 37 and relative polarization networks comprising resistors and capacitors 38, 39, 40, 41, 42, 43, 44, 45, 46, 47, 48, 49, 50, the reference signal of which is obtained from resistors 52 and 53 and a filtering capacitor 54. The circuitry suitably connected as indicated in the electrical schematic enables a differential amplifier to be formed which is able to amplify the said potential differences present across the resistors 33 and 34.

The circuit 35 amplifies the differential signal produced by the sensor 4 and at the outputs 57 and 58 of the two stage amplifier enables signals to be obtained which are amplified respectively 1000 and 100 times the level of variation of the sensed image at the inputs of said two stage differential amplifier, enabling a device with a double control scale to be formed.

Said amplified signals are fed to the gates 60 and 61 of the unit 6 and can be converted in known manner from analog signals to digital signals by a usual ADC unit integrated into the unit 6 (not shown). Said conversion enables the previously amplified signals to be transformed into numerical values, said numerical values being a function of the image relative to the monitored flow; by means of a processing and comparison algorithm, they are able to determine if the image variation has level and frequency values which are equal to or greater than a programmed minimum reference value. If the image variation level and frequency values are shown to be less than the programmed reference value for an irregularity time greater than a further programmable alarm time, an alarm signal is generated by the unit 6 at an output gate 63.

By means of polarization resistors 70 and 71, the signal leaving the gate 63 activates an output transistor 75, to generate an alarm signal connected to a connection member 76 of a connector 77.

There is connected to the connection member 76 a usual element controlling a member (for example a bearing of a machine tool) at which the fluid 3 arrives, or controlling the feed of an article to a work station where it is subjected to the spray 13. Alternatively, there is simply connected to the member 76 a warning alarm (acoustic or light-emitting) for the textile machine or work station with which the present invention is connected.

The resistor 70, 71 and the transistor 75 form part of an alarm and protection circuit 80 connected to the aforesaid member. This circuit comprises a resistor 81 used as a shunt resistor which enables the current provided by the transistor 75 to be measured, the voltage drop across it being a function of the operated current, i.e. the current relative to the load which is to be piloted, for example a solenoid control valve or more simply the stop relay of the machine tool; this control enables damage to the transistor 75 to be prevented in the case of mistaken connection, for example a short circuit, or excessive current absorption.

This voltage drop is measured by the unit 6 via a gate 82 connected to the circuit 80 by a decoupling resistor 83, and provides protection against any short-circuiting at the member 76; in this respect in the case of extra current exceeding the defined maximum value, the unit 6 deactivates the transistor 75 to protect the member 76.

A diode 84 also acts as protection against voltage reversal between the collector and emitter of the transistor 75.

A circuit 88 displaying the correct operation of the flow feed monitoring device is also connected to the unit 6. This display circuit 88 comprises transmitters or LEDs 89 and 90 which are connected to output gates 91 and 92 of the unit 6 by polarization resistors 93 and 94. These LEDs generate lights of different colours (for example green and red) to indicate correct operation of said device.

The circuit 88 is also connected to a circuit 96 acting as the device resetting circuit. This circuit 96 comprises a photodiode 97 polarized by a resistor 98 and piloted by the unit 6 via a gate 99 thereof. The circuit comprises a phototransistor receiver 100 and a polarization resistor 101 which define an optical reflection key, the activation state of which can be read by the unit 6 by an input reading at a gate 103. This optical key can be used as the RESET key of the device of the invention.

In addition to the other usual connection members, the connector 77 comprises an input 106 enabling a programming/communication unit (not shown) to be connected to the device to enable the limiting image variation level parameters and relative alarm times to be programmed, on exceeding which the unit 6 generates a STOP signal via the member 76 and activates the LED or alarm (for example red) 90.

Said communication takes place via the respective RX input and TX output of the unit 6 interfaced at the connector 77 via an input decoupling resistor 107 and an output buffer 108 respectively. That circuit portion comprising said buffer 108 and the resistor 107 is connected to outputs and inputs 110, 111 and 112 of the unit 6 (the RX input coinciding with the input 100 and the TX output coinciding with the output 111) and represents a programming interface 113. By means of this, alarm times and flow monitoring values can be programmed.

The circuit schematic of FIG. 3 also comprises a feed circuit 114 formed by known L-C low pass filters defined by an inductor 115 and capacitor 116, a protection/feed polarity reversal diode 117, a first stabilizer circuit 118 and relative polarization components 119 and 120, and the filter 121 the values of which predetermine the stabilized output voltage of the circuit 118 identified by VCC and fixed at 5 V.

A second feed stage of 3.3 V is formed by a second stabilizer circuit 125 and relative antidisturbance filters consisting of capacitors 126 and 127.

The circuit 114 is connected to a power reset circuit 130 comprising a third stabilizer circuit 131 connected to resistors 132 and 133, this latter being connected to a gate 134 of the unit 6; this circuit enables correct data control and salvaging in case of network defects or holes or network voltage drops.

The circuit schematic also shows other members which have not been described, but which define known parts having functions evident to the expert of the art in the light of the aforegoing description and the circuit schematic itself.

One embodiment of the invention has been described; others are however possible in the light of the aforegoing description and are to be considered as falling within the present document.

1. A device for monitoring the flow of a fluid (3, 13) flowing through or from a conduit (2), such as a lubricant or an article treatment fluid, said fluid being a liquid, a gas or containing powder in suspension, said device comprising light-emitting means (1) arranged to irradiate a light radiation towards said flow of fluid (3, 13) and sensor means (4) for said radiation, characterised in that the sensor means are image sensors arranged to sense the image projected onto them by the fluid (3, 13) struck by said light radiation, said image sensor means (4) generating at least one output signal (I1, I2) depending on the presence thereon of the sensed flow image, said signal representing in this manner characteristics of the fluid passing through the conduit or emerging from it such as its state of movement or rest, its flow rate or its direction in space.

2. A device as claimed in claim 1, characterised in that the fluid being monitored is an atomized fluid (13).

3. A device as claimed in claim 1, characterised in that the fluid (3) lies between the light-emitting means (1) and the sensor means (4).

4. A device as claimed in claim 1, characterised in that the fluid (13) lies on one side of the light-emitting means (1) and of the sensor means (4), which themselves are located on the same side of the fluid (13).

5. A device as claimed in claim 1, characterised in that the sensor means (4) are a photosensitive element.

6. A device as claimed in claim 1, characterised in that the sensor means (4) are an optical sensor.

7. A device as claimed in claim 6, characterised in that the optical sensor is a PSD.

8. A device as claimed in claim 6, characterised in that the optical sensor is a CCD.

9. A device as claimed in claim 1, characterised in that the sensor means (4) are connected to microprocessor evaluation and control means (6) to which the at least one signal emitted by said sensor means is fed.

10. A device as claimed in claim 1, characterised in that the sensor means emit two signals (I1 I2) on the basis of the sensed fluid image.

11. A device as claimed in claim 1, characterised in that the signal emitted by the sensor means is an electrical signal.

12. A device as claimed in claim 1, characterised in that the signal emitted by the sensor means is a digital signal.

13. A device as claimed in claim 9, characterised in that the evaluation and control means (6) are programmable via a programming interface (113) to which these means are connected.

14. A device as claimed in claim 9, characterised in that the evaluation and control means (6) are part of an electrical circuit comprising a resetting circuit (96) and an alarm and protection circuit (80).

15. A device as claimed in claim 14, characterised in that the alarm and protection circuit (80) is connected to a connection member (76) for connecting the device to a member receiving the fluid being monitored.

16. A method for monitoring the flow of a fluid (3, 13) flowing through or from a conduit (2), such as a lubricant or an article treatment fluid, said method consisting of generating a light radiation which is directed towards said fluid, and is then sensed after the fluid has interfered with it, characterised by comprising:
a) sensing the image of said fluid generated on image sensor means (4) which are struck by the light radiation directed towards the fluid (3, 13);
b) comparing the sensed image of the fluid with predetermined values to identify characteristics of the fluid such as its state of movement, its state of rest, its flow rate, or its direction in space.

17. A method as claimed in claim 16, characterised in that the fluid image is sensed by reflection of the light radiation which strikes it.

18. A method as claimed in claim 16, characterised in that the fluid image is sensed indirectly via the shadow which it projects onto the image sensor means (4).

19. A method as claimed in claim 16, characterised in that the fluid flow rate is regulated on the basis of the sensed fluid characteristics.

20. A method as claimed in claim 16, characterised in that a member reached by the fluid being monitored is acted upon to regulate its operation on the basis of the characteristics of the sensed fluid.

21. A method as claimed in claim 20, characterised in that said regulating of the operation of the member reached by the fluid being monitored also includes halting said member.

22. A method as claimed in claim 20, characterised in that said regulating of the operation of the member reached by the fluid being monitored includes regulating its spatial attitude.
